(19) United States
(12) Patent Application Publication
(10) Pub. No.: US 2010/0216631 A1
(43) Pub. Date: Aug. 26, 2010

(54) METHOD AND APPARATUS FOR FLUID-LIQUID REACTIONS

(76) Inventors: Xiong-Wei NI, Edinburgh (GB); Andrew Fitch, Lanarkshire (GB); Ian Laird, Glasgow (GB)

Correspondence Address: KED & ASSOCIATES, LLP, P.O. Box 221200, Chantilly, VA, 20153-1200, US

(21) Appl. No.: 11/993,175

(22) PCT Filed: Jun. 23, 2004
(86) PCT No.: PCT/GB06/02323

§ 371 Date: Apr. 14, 2010

(30) Foreign Application Priority Data
Jun. 23, 2005 (GB) 0512794.9

(51) Int. Cl. B01J 35/00; B01J 8/00; B01J 19/18; B01J 8/16

(52) U.S. Cl. 502/100; 422/220; 422/191; 422/196

(57) ABSTRACT

A method and apparatus for fluid-liquid reactions including gas-liquid and liquid-liquid reactions. The method and apparatus is suitable for mixing a fluid phase species and a liquid phase species to facilitate chemical reaction between said phases. The apparatus comprises a reactor vessel with a plurality of orificed plates and flow control means which initiates and maintains uniform mixing and efficient dispersion of a fluid-liquid mixture within the reactor vessel.

The present invention relates to a method and apparatus for fluid-liquid reactions.

Fluid-liquid reactions can include gas-liquid and liquid-liquid reactions, for example: hydrogenation, hydroformylation, oxidation, reductions, chlorination, de-odourisation, fermentation and aerobic processing; liquid-liquid reactions such as the use of acids in aromatic nitration; the hydrolysis of nitriles to amides using either acid or base; and the hydrolysis of amides using either acid or base; the use of solvents in trans-esterification; the use of molten fluid(s) in polyurethane dispersion; and the use of supersaturated fluids in gas hydrates.

In the field it is known to perform gas-liquid reactions in a batch process. Such processes normally involve the use of a stirred tank reactor, in which fluids are mixed by means of one or more impellers in fixed positions with the presence of baffles within the tank. The gas phase is charged into the reactor through a sparger or spargers.

The use of impellers in large stirred tank reactors causes gradients in mixing, hence inhomogeneity within the mixing of the gas and liquid, providing poor dispersion and mass transfer characteristics, leading to products with inconsistent quality.

Some types of gas-liquid batch reaction processes are performed without catalysts at ambient pressures and room temperature. Examples of such processes are the transfer of gas into liquid media in aerobic wastewater treatment, transfer of gas into yeast culture or yeast resuspension and transfer of oxygen into bacteria and cells in fermentation of bacteria, biopolymers and cells; or consuming CO₂ in liquid media in carbonation reactions.

Some types of gas-liquid batch reactions are operated at either room or elevated pressures and temperatures, for instance, hydrogenation, hydroformylation, oxidation, de-odourisation and chlorination. For some of these reactions, a certain catalyst is required. The catalyst can be of either solid or liquid form.

European Patent EF1076597 discloses the use of an apparatus and method for phase separated synthesis in which an aqueous media is continuously fed through a reactor vessel and reacts with an organic liquid phase to provide for the phase separated synthesis of particulates in a continuous manner at ambient pressure and elevated temperatures.

Hydrogenation is one of the most commonly used chemical processes. The “normal” way of performing this type of reactions is through large scale batch processes. For the fine and speciality chemical industry, as well as companies producing pharmaceutical intermediates, this provides a number of problems:

i) plant is expensive and cannot often be justified on site;
ii) to operate the batch process “economically”, larger quantities of product are produced;
iii) product lead times are poor; and
iv) flexibility and responsiveness is poor and therefore detrimental to customer service

Until now there has been no feasible way to cost effectively hydrogenate products in small quantities in line with the true demand that is undistorted by supply chain inadequacies.

In accordance with the first aspect of the invention, there is provided an apparatus for mixing a fluid phase species and a liquid phase species to facilitate chemical reaction between said phases, the apparatus comprising:
a reactor vessel;
first supply means to supply a feed of the liquid phase species through the reactor vessel;
second supply means to supply the fluid species to the reactor vessel; and
a plurality of orificed plates and flow control means adapted to initiate and maintain uniform mixing and efficient dispersion of a fluid-liquid mixture within the reactor vessel.

In the context of this description orificed plates are understood to be substantially flat plates that control or direct the flow of fluids including liquids and gases.

The orificed plates are adapted to perform the function of stationary baffles or a reciprocating agitator.

The stationary baffles can be formed as an integral part of the tubular reactor using the same material, e.g. glass periodic restrictions manufactured within any length and shape of a tube.

The apparatus and method of the present invention relates to fluid-liquid reactions operable at variable pressures and temperatures, operated as either batch, semi-batch/fed-batch or continuous processes. The liquid may be a solution, a pure liquid, an emulsion or a suspension of particulates in a liquid.

The fluid phase can be a gas phase, for example: H₂ in hydrogenation and hydroformylation; air or O₂ in fermentation, oxidation and aerobic digestions; air and CO₂ in aqueous mediums containing cyanobacteria for hydrogen generation; and Cl₂ in chlorination.

The fluid phase can be a liquid phase, for example: acids in aromatic nitration; the hydrolysis of nitriles to amides using either acid or base; and the hydrolysis of amides using either acid or base; the use of solvents in trans-esterification; the use of molten fluid(s) in polyurethane dispersion; and the use of supersaturated fluids in gas hydrates.

Preferably the orificed plates are substantially flat plates comprising an aperture located approximately centrally in said plate.

The aperture may be adapted to impart a substantial amount of unsteadiness in flow on the fluid-liquid mixture.

The orificed plates produce turbulence on fluids that contact them as they flow through the reactor vessel and thus provide intimate mixing. The turbulence produced by the orificed plates provide more efficient and uniform mixing.

The aperture is of sufficient size to impart a substantial amount of unsteadiness in flow, and hence intimate mixing, to fluids that flow past and contact the orificed plates.

Preferably, at least one access port is provided for the introduction of other reactant species into the reactor vessel.

The orificed plates may be attached to at least one supporting rod or form part of the vessel. The supporting rods can be situated parallel with at least part of the length of the reactor vessel.

Preferably, a catalyst is provided in the reaction vessel.

Preferably, the reactor vessel further comprises pressure alteration means for changing the pressure in the reactor vessel.

Preferably, the pressure alteration means may alter the pressure between vacuum and 1000 bar.

Preferably, the second supply means allows for the controlled addition of the gas.

Preferably, the second supply means allows for the controlled addition of the gas with a micro-porous sparger.

This promotes fuller reactions with less side reactions and pollutes, therefore assists in the control of product formation.

Preferably, the position(s) along the length of the reactor at which the fluid may be added is controllable.

Preferably, the flow control means comprises an oscillator adapted to impart motion to the rector vessel constituents.

Preferably, the motion is oscillatory motion.

Preferably, the oscillator is a pressure piston.

Optionally, the oscillator is provided with a pressure diaphragm.

Optionally, the oscillator is provided with a pressure bellows.

Preferably, the oscillator and the reactor vessel are sealed with a rotary seal.

Optionally, the oscillator and the reactor vessel are sealed with a high pressure seal.

Optionally, the gas input is controlled by the pulsed supply of gas.

Preferably, the micro-porous sparger is used for the supply of gas.

Preferably, the catalyst is a homogeneous catalyst dissolved in the liquid.

Preferably, the catalyst is a heterogeneous catalyst that is either suspended in the liquid or present as a solid.

Optionally the catalyst is contained in one or more meshed bags, the meshed bags being attached to at least one of the plurality of orificed plates.

The orificed plates may be manufactured with hollow compartments that contain catalyst.

Optionally, the heterogeneous catalyst is applied to one or more surfaces within the reactor.

Optionally, the catalyst is applied as a coating to the one or more orificed plates.

Optionally, the orificed plates may be manufactured with the catalyst already present.

Optionally, the heterogeneous catalyst is transportable through the reactor vessel.

Optionally, both heterogeneous and homogeneous catalysts are included in the reactor vessel.

Optionally the heterogeneous catalyst is stationary throughout the reaction vessel.

The stationary catalyst may comprise different catalysts.

The different catalysts may be arranged in the reactor vessel in a selected order of reactivity. For example, the stationary catalyst may comprise several different catalysts selected to catalyse different reactions.

The selected order of reactivity may be ascending or descending order of reactivity.

Optionally, the apparatus further comprises at least one manifold operatively connected to the reactor vessel.

The reactor vessel may comprise a plurality of branches operatively connected to the at least one manifold.

Optionally the plurality of branches comprises stationary heterogeneous catalysts, wherein different branches comprise different catalysts.

The apparatus may be provided with a circulation or feedback means to allow the contents of a reactor vessel that have exited the reactor vessel to be fed back into the reactor vessel. Similarly the apparatus is provided with a circulation or feedback means to allow the contents of reactants that have exited the feed vessel to be fed back into the feed vessel.

In accordance with a second aspect of the invention, there is provided, a process for mixing a fluid phase species and a liquid phase species to facilitate chemical reaction between said phases, the process comprising the steps of:

feeding a liquid reactant into a reactor vessel;
supplying a fluid to the reactor vessel;
imparting motion to a fluid-liquid mixture to initiate and maintain uniform mixing and efficient dispersion of the mixture in the vessel.

Preferably, the reaction process is a semi-continuous or fed-batch process.

Preferably, the process further comprises at least one port for introducing other reactant species or a catalyst into the reactor vessel.

Preferably, the process further comprises changing the pressure in the reactor vessel.

Preferably, the process further comprises altering the pressure between vacuum to 1000 bar.

Preferably, the process further comprises selectively controlling the rate at which fluid is added to the reactor.

Preferably, the process further comprises selectively controlling the position along the length of the reactor at which the fluid is added.

Preferably, the motion is imparted by means of an oscillator.

Optionally, the gas supply to the reactor vessel is pulsed.

Preferably, a micro-porous sparger is used for the supply of gas.

Preferably, the catalyst is a homogeneous catalyst dissolved in the liquid.

Preferably, the catalyst is a heterogeneous catalyst that is either suspended in the liquid or present as solid.

Optionally, the process further comprises applying the heterogeneous catalyst to one or more surfaces within the reactor.

Optionally, the catalyst is applied as a coating to at least one orificed plate.

Optionally, the heterogeneous catalyst is transportable through the reactor vessel.

Optionally, both heterogeneous and homogeneous catalysts are included in the reactor vessel.

The present invention will now be described by way of example only, with reference to the accompanying drawings in which:

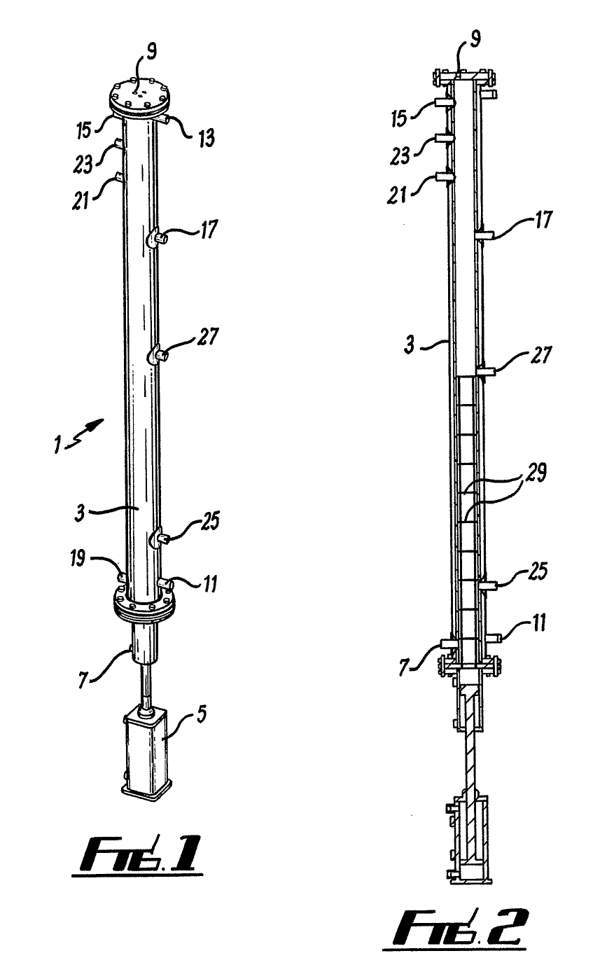

FIG. 1 is a perspective view of a reactor vessel in accordance with the present invention;

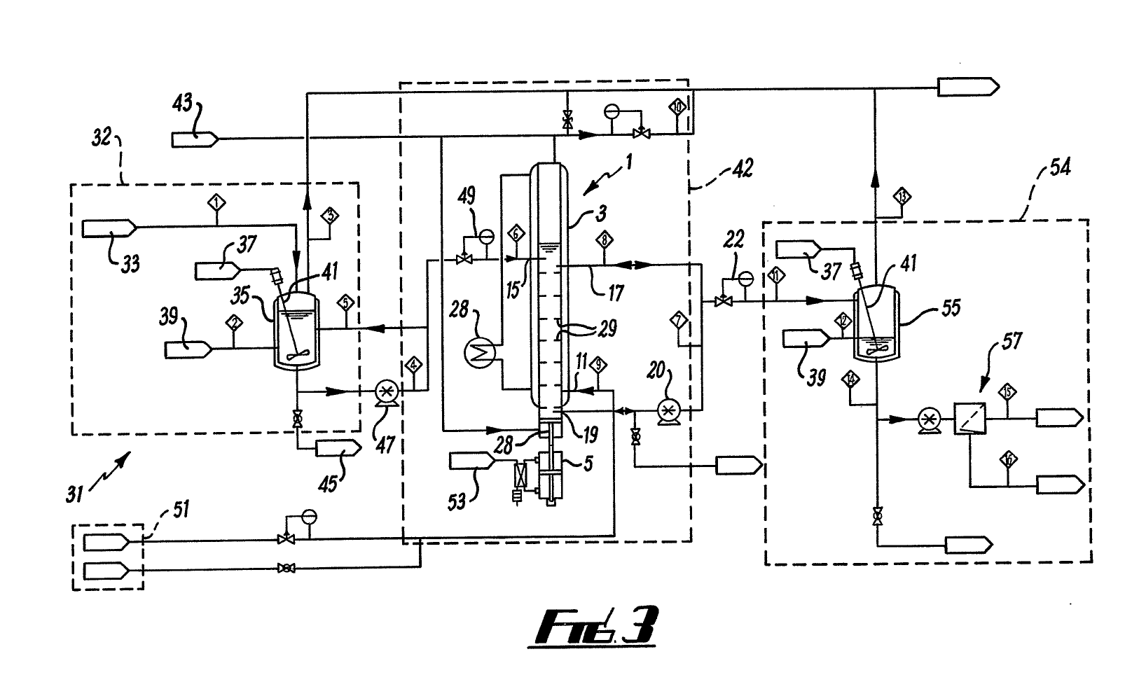

FIG. 2 is a cross-sectional view of the reactor assembly of FIG. 1; and

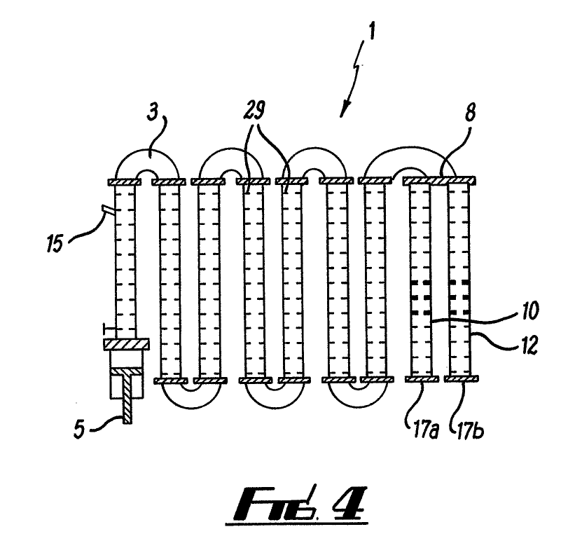

FIG. 3 is a schematic diagram showing the reactor of FIG. 1 and FIG. 2 used in a process in accordance with the present invention.

FIG. 4 is a plan cross-sectional view of a serpentine flow path reactor with a manifold according to one embodiment of the present invention;

FIG. 1 shows a reactor assembly 1 comprising a column 3, a piston 5, which in this example is provided with an air ram.

A number of inlet and outlet ports are situated along the length of column 3, the ports are designed to allow reactants and products to be added and removed from the reactor, and in addition provide sensing means and means for modifying the reactor temperature and pressure. In FIG. 1, hydrogen inlets 7 and inlet/outlet 9 are shown along with reactant inlet 15, heating or coolant inlet 11 and heating or coolant outlet 13, product recirculation port 19, product outlet 17, high and low level sensors 23 and 25, thermal couple 27 and pH sensor 21.

FIG. 2 is a cross-sectional view of the reactor assembly of FIG. 1, which in addition to the features of FIG. 1, shows the stationary baffles 29 spaced along the length of the reactor. In addition, the air ram 5 is shown. This air ram 5 uses compressed air to move the piston which provides an initial oscillation of the contents of the reactor column. In the above example of the present invention, the piston bore is around 50 mm and travels a maximum of around 30 mm. The air flow to the air ram determines the rate of oscillation of the piston. Control means are provided to control both the stroke length and the frequency of oscillation of the piston.

The orificed plates may be attached to supporting rods that may be situated parallel with at least part of the length of the reactor vessel. Where the reactor is designed to operate under conditions other than atmospheric pressure, there is a need to ensure that the reactor assembly can remain pressurised during reaction of the piston. Accordingly, a rotary seal or pressure diaphragm may be provided in order to stabilise and maintain the pressure within the reactor.

FIG. 3 shows a system for operating a gas liquid reaction in accordance with the present invention. The system 31 can be notionally divided into three sections, identified by boxes 32, 42 and 54. Box 32 shows schematically the materials and processes required in order to prepare liquid reactants for use in the present invention. Box 42 shows the reactor along with the various other implements required for the gas liquid reaction of the present invention and box 54 shows the manner in which the product of the reaction is treated after the reaction has occurred.

A raw material feed is connected to a feed tank 35, which is provided with a stirrer 41. A nitrogen feed 39 is provided to purge the feed tank prior to use. A feed pump 47 is provided for pumping the liquid reactants that may or may not contain catalyst(s) into the reactor column 3. The feed pump 47 may be pressurised and balanced with the operation of the main reactor 1. In addition, a drain 45 is provided for the collection of excess reactants.

As shown in box 42, the reactor assembly 1 is substantially identical to the reactor assembly shown in FIGS. 1 and 2. The heater/chiller 28 is provided and is attached to the thermal couple 27 (not shown here) in order to control the temperature of the column 3. Hydrogen source 43 is attached to hydrogen inlets 7 and 9 of FIGS. 1 and 2, and the reactants inlet 15 is attached to a valve 49, which allows reactants to be controllably added to the column 3. Orificed plates (orificed baffles) 29 are also shown, along with the piston 28 attached to the air ram 5, which has a compressed air source 53 also attached to it. Product recirculation inlet 17 is attached to product pump 20 and product outlet 19. A control valve 22 is also attached to the product outlet, and this valve allows the product to be drawn off from the outlet 17. The control valve 22 may also be used to depressurise the reactor system.

Box 54 shows a product tank also having air 37 and nitrogen 39 sources attached thereto, along with a stirrer 41 adapted to stir the product in the product tank 55. Separation means 57 are included for removal of any catalysts or any other material from the product using a pressure filter or the like as a purification means.

FIG. 4 shows a cross-sectional view of a reactor assembly 1 comprising a serpentine flow path reactor 3 with a manifold 8. Along the length of the reactor 3 there are placed stationary baffles 29. In addition, the air ram 5 is shown. Reactant can be added to the reactor 3 through the inlet port 15. Positioned along the reactor 3 is a manifold 8. Following the manifold 8, the reactor 3 is split into two branches 10 and 12 with disparate fluid pathways. The two different branches comprise different stationary heterogeneous catalysts. Each catalyst is selective for, or favours, a particular reaction. Therefore disparate catalytic reactions proceed simultaneously, concurrently producing different product at outlets 17a and 17b.

Use of the system of FIG. 3 will now be described with reference to the production of biodiesel using heterogeneous solid catalyst. An oil (vegetable oil, corn oil, sunflower oil, rapeseed oil, palm oil, soybean oil, Jatropha, animal tallow, etc) is mixed with methanol (ratio 1:3 to 1:10) with the presence of a solid catalyst (1 mol % to 20 mol %) with co-solvent in the reactor 3. The mixture is oscillated and heated from room temperature to 200° C. for 1 to 4 hrs. After this time, oil and methanol with the same ratio from the oil feed tank 41 and the methanol feed tank (not shown) are continuously fed into the reactor 3 at any desirable rate. The products are a mixture of biodiesel and glycerol which are continuously drawn out of the reactor 3, at the same rate, to the product tank 55. A fraction of the mixture can be recycled back to the reactor 3. The solid catalyst remains suspended in the reactor 3. The product stream is then transferred to the product tank 55 where the heavier glycerol layer is separated from the mixture. The biodiesel is obtained after distilling off excess methanol and co-solvent from the upper layer of the mixture. Alternatively a separation tower is utilised so that the separation of biodiesel from glycerol is carried out continuously.

Alternatively the reaction can be operated under elevated pressures, under these conditions, the reaction time is reduced. The reaction can be performed without a co-solvent.

Use of the system of FIG. 3 will now be described with reference to the product of the hydrogenation reaction for the continuous manufacture of a major ingredient for photo developer.

Firstly the reactor 3, the feed tank 41 and the product tank 55 are purged with nitrogen. The feed tank is then opened and charged with a heterogeneous catalyst, an intermediate and solvent at ambient pressure. The feed tank is then agitated using the stirrer 41 for a certain amount of time and the valve 49 is opened to allow the feed to be added to the reactor 3 to a predetermined level.

Thereafter, oscillation of the contents of the reactor is commenced using the pneumatic piston 5, and the reactor, feed tank and product tank are pressurised to 3 bar using nitrogen. Hot water is used to increase the temperature of the reactor to between 38° C. and 42° C. with a view to stabilising the temperature of the reactor at around 40° C.

The next step is the switching on of the gaseous hydrogen feed at a predetermined flow rate that allows the gas to bleed out to stabilise the pressure of the system at 3 bar, such that the nitrogen in the reactor 3 is replaced by hydrogen. The hydrogenation reaction takes place within the reactor over a period of one reaction time, in this case, one to two hours at a pressure of 3 bars and a temperature of 48° C. to 52° C.

Continuous hydrogenation can be achieved by simultaneously opening the valves to let the feed enter the reactor and the product to leave the reactor at preset rates.

The apparatus can be operated continuously, in a semi-batch or fed batch process. In the fed batch process, a liquid batch is added and the fluid fed through the liquid to provide efficient and effective mixing. Re-circulation of the products and/or unused reactants is provided for in a semi-batch process.

The apparatus and process is suitable for use in aqueous and non-aqueous reactions, and in gas-liquid and liquid-liquid reactions.

The present invention enables shorter, faster chemical reactions due to uniform mixing, efficient dispersion and enhanced mass transfer rates, and is suitable for hydroformylation, oxidation, chlorination and reduction reactions including hydrogenation. In the present process, the heterogeneous catalyst is suspended in a liquid phase. In addition, one or more embodiments of the present invention are envisaged where the use of heterogeneous catalysts within the reactor.

It is envisaged that these heterogeneous catalysts might be applied to the inner surfaces of the reactor vessel suitably to one or more of the baffles. The catalyst may be applied as a coating to the baffles, or catalyst bags may be attached to one or more baffles, or the baffles may be manufactured with hollow apartments that contain catalyst. The catalyst can be in meshed bags attached to one or more baffles.

In addition, or alternatively, the catalyst may be suspended in the reactor vessel.

The heterogeneous catalyst can be stationary throughout the reactor vessel. The stationary catalyst can comprise different catalysts arranged in the reactor vessel in a selected order of reactivity. For example, the selected order can be ascending or descending order of reactivity. The catalysts can be placed strategically to provide predetermined reactions sequences and to facilitate “organic” enzymatic reactions. The use of stationary catalysts removes the need to separate the catalyst from the reaction stream post-reaction.

In one embodiment the reactor vessel of the apparatus further comprises a manifold which is connected to the reactor vessel. The manifold splits the reactor vessel into several branches. Different branches comprise different stationary heterogeneous catalysts. Each catalyst can be selective for, or may favour, a particular reaction. This allows disparate catalytic reactions to proceed simultaneously, concurrently producing more than one type of product.

A further innovation in the present invention is the ability to introduce a homogeneous catalyst into the feed that is introduced into the reactor 3 for use in a fluid liquid reaction in an oscillatory baffled reactor, as described with reference to FIGS. 1 and 2. The present invention further allows the possibility for recombination of heterogeneous and homogeneous catalysts within the reactor at the same time. Furthermore, temperature and pressure can be controlled whilst using both homogeneous and heterogeneous catalysts.

The present invention as described with reference to FIGS. 1 to 3 may also be used in a semi-batch/fed-batch operation. In these cases, the liquid feed may be in a counter flow arrangement with respect to the fluid. The use of an oscillatory baffled reactor in this way allows a greater degree of control over the chemical process, whilst not requiring the full length of a continuous oscillatory baffled reactor that is required to deliver pseudo plug flow.

A further innovation in the present invention is the flexibility to perform similar types of reactions without the presence of catalyst(s) in batch, semi-continuous/fed-batch and continuous operations, for example: carbonation processes on polyamine; hydrolysis of nitriles to amides using base or acid; hydrolysis of amides using base or acid; acids in aromatic nitration.

In this fed-batch continuous operation, the product is of a solid form, hence in the recirculation lines that are used in the fed-batch reactions and in the product tubes of the continuous reactors, solids are suspended and transported along the reactor, the content of solids can be as high as 50%. The uniform and enhanced mixing achieved in this type of reactor can give rise to an effective solid suspension and which can be transported in the baffled tubes with or without oscillation.

In all of the above cases, the reactor vessel used provides for efficient mixing and dispersion of the reactants, and good control of reaction conditions to provide and control the type, shape, size and homogeneity of the reaction of the products that are made.

In general, a combination of good mixing (in which plug flow can be achieved) and very good mass transfer characteristics creates a very effective reactor. This enables reaction times to be significantly reduced in a continuous manner with the reaction time being about 80% faster than traditional approaches.

A reactor with more efficient and uniform mixing, and much better mass transfer rates avoids the need for scale up and allow reactors to be much smaller (by factor of 30˜40 fold). This reduces capital costs, space and other overhead requirements and the smaller plant has lower operating costs. Additionally, the plant is skid-mounted and portable.

Improvements and modifications may be incorporated herein without deviating from the scope of the invention.

1.-57. (canceled)

58. A continuous, semi-continuous or fed-batch apparatus for heterogeneous catalysis, the apparatus comprising:
a reactor vessel provided with a heterogeneous catalyst;
first supply means to supply a feed of a liquid phase species through the reactor vessel;
second supply means to supply a fluid species to the reactor vessel;
flow control means comprising an oscillator adapted to impart oscillatory motion to the reactor vessel constituents; and
plurality of orificed plates adapted to initiate and maintain uniform mixing and efficient dispersion of a fluid-liquid mixture within the reactor vessel.

59. An apparatus as claimed in claim 58, wherein the reactor vessel further comprises pressure alteration means for changing the pressure in the reactor vessel.

60. An apparatus as claimed in claim 58, wherein the second supply means allows for the controlled addition of gas.

61. An apparatus as claimed in any claim 60, wherein gas input is controlled by the pulsed supply of gas.

62. An apparatus as claimed in claim 58, wherein the heterogeneous catalyst is suspended in the reactor vessel.

63. An apparatus as claimed in claim 58, wherein, the heterogeneous catalyst is applied to one or more surfaces within the reactor vessel.

64. An apparatus as claimed in claim 63 wherein the heterogeneous catalyst is applied as a coating to at least one orificed plate.

65. An apparatus as claimed in claim 58, wherein the heterogeneous catalyst is contained in one or more meshed bags, the meshed bags being attached to at least one orificed plate.

66. An apparatus as claimed in claim 58, wherein the orificed plates are manufactured with hollow compartments that contain heterogeneous catalyst.

67. An apparatus as claimed in claim 58, wherein both heterogeneous and homogeneous catalysts are included in the reactor vessel.

68. An apparatus as claimed in claim 58, wherein the heterogeneous catalyst is transportable through the reactor vessel.

69. An apparatus as claimed in claim 58, wherein the heterogeneous catalyst is stationary throughout the reactor vessel.

70. An apparatus as claimed in claim 69, wherein the stationary catalyst comprises different catalysts.

71. An apparatus as claimed in claim 70, wherein the different catalysts are arranged in the reactor vessel in a selected order of reactivity.

72. An apparatus as claimed in claim 58, the apparatus further comprising at least one manifold operatively connected to the reactor vessel, the reactor vessel comprising a plurality of branches operatively connected to the at least one manifold, the plurality of branches comprising stationary heterogeneous catalysts, and wherein different branches comprise different catalysts.

73. An apparatus as claimed in claim 58, wherein the apparatus is provided with a circulation or feedback means to allow the contents of a reactor vessel that have exited the reactor vessel to be fed back into the reactor vessel.

74. A continuous, semi-continuous or fed-batch process for heterogeneous catalysis, the process comprising the steps of:
feeding a liquid reactant into a reactor vessel;
supplying a fluid to the reactor vessel;
providing a heterogeneous catalyst to the reactor vessel;
imparting oscillatory motion to the reactor vessel constituents by means of an oscillator; and
initiating and maintaining uniform mixing and efficient dispersion of a fluid-liquid mixture in the reactor vessel with a plurality of orificed plates.

75. A process as claimed in claim 74, wherein the process further comprises changing the pressure in the reactor vessel.

76. A process as claimed in claim 74, wherein the process further comprises selectively controlling the rate at which fluid is added to the reactor.

77. A process as claimed in claim 74, wherein a gas supply to the reactor vessel is pulsed.

78. A process as claimed in claim 74, wherein the heterogeneous catalyst is applied to one or more surfaces within the reactor.

79. A process as claimed in claim 78, wherein the heterogeneous catalyst is applied as a coating to at least one orificed plate.

80. A process as claimed in claim 74, wherein the heterogeneous catalyst is transportable through the reactor vessel.

81. A process as claimed in claim 74, wherein the heterogeneous catalyst is contained in one or more meshed bags, the meshed bags being attached to at least one orificed plate.

82. A process as claimed in claim 74, wherein the orificed plates are manufactured with hollow compartments that contain heterogeneous catalyst.

83. A process as claimed in claim 74, wherein the heterogeneous catalyst is stationary throughout the reactor vessel.

84. A process as claimed in claim 83, wherein the stationary catalyst comprises different catalysts.

85. A process as claimed in claim 84, wherein the different catalysts are arranged in the reactor vessel in a selected order of reactivity.

86. A process as claimed in claim 74, wherein both heterogeneous and homogeneous catalysts are included in the reactor vessel.

87. A continuous, semi-continuous or fed-batch apparatus for gas-liquid reactions, the apparatus comprising:
a reactor vessel;
first supply means to supply a feed of a liquid phase species through the reactor vessel;
second supply means to supply a fluid species to the reactor vessel;
flow control means comprising an oscillator adapted to impart oscillatory motion to the reactor vessel constituents; and
a plurality of orificed plates adapted to initiate and maintain uniform mixing and efficient dispersion of a fluid-liquid mixture within the reactor vessel.

88. A continuous, semi-continuous or fed-batch process for gas-liquid reactions, the process comprising the steps of:
feeding a liquid reactant into a reactor vessel;
supplying a fluid to the reactor vessel;
imparting oscillatory motion to the reactor vessel constituents by means of an oscillator; and
initiating and maintaining uniform mixing and efficient dispersion of a fluid-liquid mixture in the reactor vessel with a plurality of orificed plates.
